(19) United States
(12) Patent Application Publication
(10) Pub. No.: US 2020/0110283 A1
(43) Pub. Date: Apr. 9, 2020

(54) COLORANT COMPOSITION FOR COLORED SILICONE HYDROGEL CONTACT LENS, A COLORED SILICONE HYDROGEL CONTACT LENS COMPRISING THE SAME AND A METHOD OF MODIFYING A COLORANT FOR A COLORED SILICONE HYDROGEL CONTACT LENS

(71) Applicant: BenQ Materials Corporation, Taoyuan (TW)

(72) Inventors: Fan-Dan Jan, Taoyuan City (TW); Hsia-Hao Chang, Taoyuan City (TW)

(21) Appl. No.: 16/254,616

(22) Filed: Jan. 23, 2019

(30) Foreign Application Priority Data
Oct. 3, 2018 (TW) 107134999

(51) Int. Cl. G02C 7/04; C09B 69/10; C09D 7/41; C09D 183/12; C09D 4/06

(52) U.S. Cl. CPC G02C 7/046; C09B 69/109; C09D 4/06; C09D 183/12; C09D 7/41

(57) ABSTRACT

The invention is related to a colorant composition for the colored silicone hydrogel contact lens. The colorant composition improves the adhesion of the colorant to the surface of the silicon hydrogel contact lens and enhances the hydrophilicity and biocompatibility. The present colorant composition comprises a polydimethylsiloxane, at least one hydrophilic monomer and a polydopamine-modified colorant.

### CROSS-REFERENCE TO RELATED APPLICATION

This application claims the priority benefit of Taiwanese application serial No. 107134999, filed on, Oct. 3, 2018, which is incorporated herein by reference.

### BACKGROUND OF THE INVENTION

### Field of the Invention

The present invention relates to a colorant composition for colored silicon hydrogel contact lens and particularly, relates to a colorant composition which is not easy to fall out therefrom and provides wear comfort of the colored silicon hydrogel contact lens, a colored silicon hydrogel contact lens comprising the colorant composition and a method for modifying the colorant for colored silicon hydrogel contact lens.

### Description of Related Art

Nowadays, concerning fashion or clothes matching, people begin to wear colored contact lens capable of altering their natural iris color. However these different colored or patterned contact lens would fade or discolor so as to make the wearers have ocular allergy.

The common colored contact lens comprises a colored layer on the surface of a lens. The wearer will touch the surface of the lens during the process of wearing or cleaning the lens, the colored layer on the surface of the lens is likely to peeling off Therefore, the colorant may fall off and stick to the wearer's eye to cause the wearer's eye infection or allergies.

One of the conventional methods for manufacturing colored contact lens is to mix a colorant and the hydrophilic monomers to form a mixture, and then a colored layer is formed by printing or transferring the mixture on a surface of the contact lens. However, the method is unfavorable because the colored layer lacks the interaction force with the contact lens, so that the colored layer is easily peeling from contact lens and discoloration or fading occurs.

Another one of the conventional methods for manufacturing colored contact lens is first to form a colored layer on the contact lens surface, and then a transparent layer is covered on the colored layer to protect the colored layer from being damaged and discolored. However, this method is so complicated and costly.

Recently, the high oxygen permeability of the silicon hydrogel contact lens is favorable to the corneal health and improves the wear comfort, the silicon hydrogel contact lens is more and more popular. With the consumers' demand, it is expected to have colored silicon hydrogel contact lens. However, because of the hydrophobicity of the silicon hydrogel contact lens, the colorant composition is hard to well adhere on the surface of the silicon hydrogel contact lens. Therefore, it is proposed to use a tackifying agent added into both of the colorant composition and the transparent protective layer for the colored layer in order to adhere and cover the colored layer well effectively. However, this method is so complicated and costly.

Therefore, the present invention is directed to a colorant composition for preparing the colored layer of a silicon hydrogel contact lens. The colorant composition enhances the adhesion of the colored layer to the surface of the silicon hydrogel contact lens and provides good hydrophilic and biocompatible properties for enhancing the wearing comfort. Furthermore, the colorant is adhered firmly so as to eliminate the protective layer for the colored layer and is favorable to the wear comfort of the colored silicon hydrogel contact lens.

### SUMMARY OF THE INVENTION

The one aspect of the present invention is to provide a colored silicon hydrogel contact lens comprising a silicon hydrogel contact lens and a colored layer on one surface thereof, wherein the colored layer provides good hydrophilic and biocompatible properties for enhancing the wearing comfort.

The present invention is to provide a colorant composition for a colored silicon hydrogel contact lens to form the colored layer thereof The colorant composition can enhance the adhesion of the colored layer to the surface of the silicon hydrogel contact lens and provide good hydrophilic and biocompatible properties for enhancing the wearing comfort. The present colorant composition for colored silicon hydrogel contact lens comprises a polydimethylsiloxane, at least one hydrophilic monomer, and a polydopamine-modified colorant.

The another aspect of the present invention is to provide a method for modifying the colorant for the colored silicon hydrogel contact lens to enhance the adhesion between the colorant and the silicon hydrogel contact lens surface and the wearing comfort thereof.

The present method for modifying the colorant used in the colored silicon hydrogel contact lens comprises the steps of: (a) providing dopamine in an alkaline aqueous solution to form a polydopamine solution; (b) adding a colorant for colored contact lens into the polydopamine solution and stirring thoroughly to enable the colorant and the polydopamine to react and form a solid-state polydopamine-modified colorant; and (c) collecting the solid-state polydopamine-modified colorant.

The above and other aspects of the invention will become better understood with regard to the following detailed description of the preferred but non-limiting embodiment(s). These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details.

It is apparent that departures from specific designs and methods described and shown will suggest themselves to those skilled in the art and may be used without departing from the spirit and scope of the invention. The present invention is not restricted to the particular constructions described and illustrated, but should be construed to cohere with all modifications that may fall within the scope of the appended claims.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

The colorant composition of the present disclosure for colored contact lens comprises a polydopamine-modified colorant. It is well known that dopamine has a molecular structure and strong adhesion property similar to mussel adhesive proteins. Dopamine contains lots of catechol and amine functional groups and also exhibits excellent biocompatible and hydrophilic properties. The present invention discloses a polydopamine-modify colorant for using in the silicon hydrogel colored contact lens to enhance the adhesion between the colorant and the contact lens surface and the wearing comfort thereof.

The present colorant composition for the colored silicon hydrogel contact lens comprises a polydimethylsiloxane, at least one hydrophilic monomer and a polydopamine-modified colorant.

In an embodiment of the present disclosure, the polydimethylsiloxane used in the colorant composition for the colored silicon hydrogel contact lens can be represented by the following formula (I):

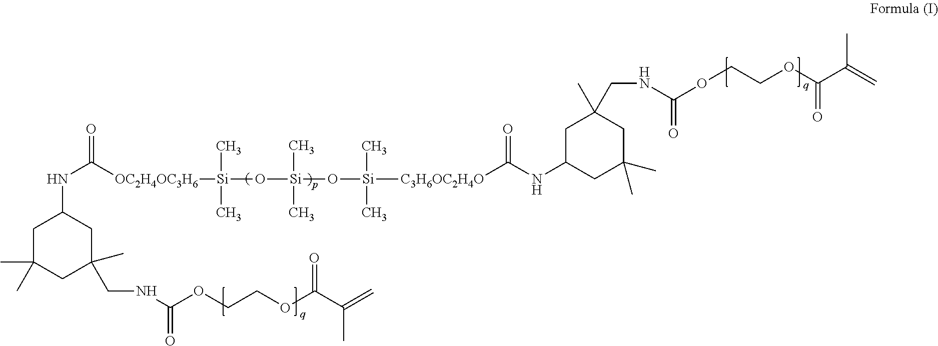

wherein, in Formula (I), p is an integer of 4 to 80 and q is an integer of 3 to 40.

The polydimethylsiloxane represented by formula (I) of the present colorant composition of the colored silicon hydrogel contact lens can be also used for preparing silicon hydrogel contact lens. Thus, the present colorant composition provides highly compatibility to the silicon hydrogel contact lens so as to be favorable for the colorant composition to adhere on the surface of the silicon hydrogel contact lens. In an embodiment of the colorant composition of the present invention, the amount of the polydimethylsiloxane is ranging from 30 weight percent to 65 weight percent relative to the total amount of the colorant composition, and preferably ranging from 35 weight percent to 60 weight percent relative to the total amount of the colorant composition, and more preferably from 40 weight percent to 50 weight percent relative to the total amount of the colorant composition.

The suitable hydrophilic monomer used in the present colorant composition can be but not limited to, for example, selected from one of the group consisting of N-vinylpyrrolidone (NVP), 2-hydroxyethyl methacrylate (HEMA), N,N′-dimethylacrylamide (DMA), methyl acrylic acid (MAA), N,N′ -diethylacrylamide, N-isopropylamide, 2-Hydroxypropyl acrylate, vinyl acetate and N-acrylolmorpholine, 2-dimethylaminoethyl acrylate, or combinations thereof. The present colorant composition is preferably to use one or more hydrophilic monomers. The amount of the hydrophilic monomer is ranging from 5 weight percent to 20 weight percent relative to the total weight of the colorant composition and preferably ranging from 8 weight percent to 15 weight percent colorant composition relative to the total weight of the colorant composition.

The suitable polydopamine-modified colorant used in the colorant composition is prepared by the method of the present disclosure for modifying the colorant of the colored contact lens.

Another aspect of the present invention is to provide a method for modifying the colorant used in a colored silicon hydrogel contact lens. The method comprises the steps of: (a) providing dopamine in an alkaline aqueous solution to form a polydopamine solution; (b) adding a colorant for colored contact lens into the polydopamine solution and stirring thoroughly to enable the colorant and the polydopamine to react and form a solid-state polydopamine-modified colorant; and (c) collecting the solid-state polydopamine-modified colorant.

In an embodiment of the present method, the concentration of the polydopamine solution is between 50 ppm and 1500 ppm and is preferably between 75 ppm and 1200 ppm.

In an embodiment of the present colored silicon hydrogel contact lens, the colorant can be organic colorant or inorganic colorant. The organic colorant can be, but not limited to, C.I. Reactive Yellow 14, C.I. Reactive Orange 7, C.I. Reactive Red 23 or C.I. Reactive Blue 19. The inorganic colorant can be, but not limited to, iron oxide black, iron oxide brown, iron oxide yellow, iron oxide red or titanium dioxide.

In an embodiment of the present colorant composition, when the coloring effect and the light transmittance of the contact lens are taken into consideration, the amount of the polydopamine-modified colorant is ranging from 10 weight percentto to 60 weight percent relative to the total weight of the colorant composition and preferably ranging from 30 weight percent to 50 weight percent relative to the total weight of the colorant composition.

In an embodiment of the present disclosure, the colorant composition further comprises an initiator.

The initiator could be a photo initiator or a thermal initiator. The suitable thermal initiator can be but not limited to, for example, azobisisoheptonitrile (ADVN), 2,2′-azobisisobutyronitrile (AIBN), 2,2′-2,2′-azobis(2,4-dimethylvaleronitrile), (2,2′-azobis(2-methyl-propanenitrile), (2,2′-azobis(2-methyl-butanenitrile), or benzoyl peroxide. The photo initiator can be but not limited to, for example, 2,4,6-trimethylbenzoyl diphenyl oxide, 2-hydroxy-2-methylphenylpropane-1-one, ethyl (2,4,6-trimethylbenzoyl) phenylphosphinate, or 2,2-diethoxyacetophenone. The amount of the thermal initiator or the photo initiator used is ranging from 1 weight percent to 5 weight percent relative to the total weight of the colorant composition.

In an embodiment of the present disclosure, the colorant composition for silicon hydrogel contact lens further comprises an anti-blue ray reagent and/or a UV reagent.

A further aspect of the present invention is to provide a colored silicon hydrogel contact lens. In an embodiment of the present invention, the silicon hydrogel colored contact lens comprises a silicon hydrogel contact lens; and a colored layer on one surface of the silicon hydrogel contact lens, wherein the colored layer comprises a colorant composition comprising a polydimethylsiloxane, at least one hydrophilic monomer and a polydopamine-modified colorant.

The following Examples are used to further describe the present invention rather than to limit thereto.

### EXAMPLE

### Preparation Example 1

### Preparation of the Polydopamine Solution

lg of dopamine was dissolved in 1000 ml of aqueous sodium bicarbonate solution (pH 8.5) and stirred for 24 hours. The resulting polydopamine solution with a concentration of 1000 ppm was obtained.

### Preparation Example 2

### Preparation of the Polydopamine-Modified Colorant I

50 g black colorant (Sicovit Black 85E172, commercially obtained from BASF, Germany) was added into 100 ml of 1000 ppm polydopamine solution. The solution was mixed and stirred at room temperature for 24 hours and allowed it to stand until the precipitate was settled. The black precipitate was collected and dried in oven to obtain a polydopamine-modified colorant I.

### Preparation Example 3

### Preparation of the Polydopamine-Modified Colorant II

The polydopamine solution of Preparation Example 1 was diluted with sodium bicarbonate solution (pH 8.5) to 500 ppm. In accordance with the procedures of Preparation Example 2, 50 g black colorant and 100 ml of 500 ppm polydopamine solution were used to prepare polydopamine-modified colorant II.

### Preparation Example 4

### Preparation of the Polydopamine-Modified Colorant III

The concentration of the polydopamine solution of Preparation Example 1 was diluted with aqueous sodium bicarbonate solution (pH=8.5) to 200 ppm. In accordance with the procedures of Preparation Example 2, 50 g black colorant and 100 ml 200 ppm polydopamine solution were used to prepare polydopamine-modified colorant III.

### Preparation Example 5

### Preparation of the Polydopamine-Modified Colorant IV

The concentration of the polydopamine solution of Preparation Example 1 was diluted with aqueous sodium bicarbonate solution (pH=8.5) to 100 ppm. In accordance with the procedures of Preparation Example 2, 50 g black colorant and 100 ml 100 ppm polydopamine solution were used to prepare polydopamine-modified colorant IV.

### Preparation Example 6

### Preparation of the Polydopamine-Modified Colorant V

The concentration of the polydopamine solution of Preparation Example 1 was diluted with aqueous sodium bicarbonate solution (pH=8.5) to 75 ppm. In accordance with the procedures of Preparation Example 2, 50 g black colorant and 100 ml 75 ppm polydopamine solution were used to prepare polydopamine-modified colorant V.

### Preparation Example 7

### Preparation of the Contact Lens Composition

4.44 g of isophorone diisocyanate, 0.0025 g of dibutyltin dilaurate as catalysts and 40 mL of methylene chloride were added into a flask to form a solution, and the solution was stirred under a stream of nitrogen. Then, 20 g of α-butyl-ω-[3-(2,2-(hydroxymethyl) butoxy) propyl] polydimethylsiloxane was accurately weighed and added dropwise to the solution over about 1 hour. After the solution reacting for 12 hours, the resulting reaction product was washed with a large amount of water, and then dehydrated and filtered to obtain a raw product. Then, the methylene chloride was evaporated to obtain a first polydimethyl siloxane macromer.

8.88 g of isophorone diisocyanate, 0.0025 g of dibutyltin dilaurate as catalysts and 40 mL of methylene chloride were added into a flask to form a solution, and the solution was stirred under a stream of nitrogen. Then, 20 g of polydimethylsiloxane was accurately weighed and added dropwise to the solution over about 1 hour. After the solution reacting at room temperature for 12 hours, another 0.0025 g of dibutyltin dilaurate and 14.4 g of polyethylene glycol monomethacrylate were accurately weighed and added dropwise to the solution over about 1 hour. After the solution reacting for another 12 hours, the resulting reaction product was washed with a large amount of water, and then dehydrated and filtered to obtain a raw product. Then, the methylene chloride was evaporated to obtain a second polydimethyl siloxane macromer.

41.8 g of the first polydimethyl siloxane macromer, 6.3 g of the second polydimethyl siloxane macromer, 0.7 g of azobisisoheptonitrile (ADVN), 46.96 g of N-vinylpyrrodine (NVP), 6.3 g of 2-hydroxyethyl methacrylate (HEMA), 1 g of ethylene glycol dimethylacrylate (EGDMA) and 25.1 g of hexanol were mixed and stirred about 1 hour to obtain a silicon hydrogel lens composition.

### Example 1

### Preparation of the Colored Silicon Hydrogel Contact Lens

6.5 g of 2-hydroxyethyl methacrylate (HEMA), 4.5 g of N,N-dimethylacrylamide (DMA), 47 g of the second polydimethyl siloxane macromer obtained in Preparation Example 7, 2.0 g of a photo initiator, 2-hydroxy-2-methylpropiophenone (trade name is UV-1173, commercially obtained from BASF, Taiwan) and 37.6 g of polydopamine-modified colorant I (Preparation Example 2) were grinded by a ball mill (RETSCHPM 400) to form a colored layer composition.

The obtained colored layer composition was transferred to a polypropylene (PP) mold and photo-polymerized to make a colored layer. The silicon hydrogel contact lens composition obtained in Preparation Example 7 was quantitatively dropped in to the PP mole and cured at 80° C. for 5 hours, then at 115° C. for 2 hours. After the polymerization was completed, the mold was immersed in alcohol for 1 hour and the resulting molded silicon hydrogel contact lens was taken out of the mold. The resulting colored silicon hydrogel contact lens was conducted a hydration treatment to obtain the colored contact lens. The obtained colored silicon hydrogel contact lens was sterilized at 121° C. for 30 minutes.

Hydration procedure is as follows:
(a) soaking the lens in 80% alcohol for 1 hour, and taking out the lens;
(b) soaking the lens in 90% ethanol for 1 hour, and taking out the lens;
(c) immersing the lens in water and heating at 80° C. for 1 hour, and taking out the lens; and
(d) balancing the lens in a buffer solution for 12 hours.

### Example 2

### Preparation of the Colored Contact Lens

The method for preparing the colored contact lens of the Example 2 was same as Example 1, except that the colorant used in the colored layer composition of Example 2 is the polydopamine-modified colorant II of the Preparation Example 3.

### Example 3

### Preparation of the Colored Contact Lens

The method for preparing the colored contact lens of the Example 3 was same as Example 1, except that the colorant used in the colored layer composition of Example 3 is the polydopamine-modified colorant III of Preparation Example 4.

### Example 4

### Preparation of the Colored Contact Lens

The method for preparing the colored contact lens of the Example 4 was same as Example 1, except that the colorant used in the colored layer composition of Example 4 is the polydopamine-modified colorant IV of Preparation Example 5.

### Example 5

### Preparation of the Colored Contact Lens

The method for preparing the colored contact lens of the Example 5 was same as Example 1, except that the colorant used in the colored layer composition of Example 5 is the polydopamine-modified colorant V of Preparation Example 6.

### Comparative Example 1

### Preparation of the Colored Contact Lens

The method for preparing the colored contact lens of the Comparative Example 1 was same as Example 1, except that the colorant used in the colored layer composition is the non-modified black colorant (Brand name: Sicovit Black 85E172, commercially obtained from BASF, Germany)

The physical properties of the colored contact lens prepared from Example 1 to Example 5 and Comparative Example 1 were measured according to the following measuring method. The resulting data were listed in the Table 1.

### Physical Properties Determination

### (A) Measurement of the Water Content

The contact lens was immersed in the phosphate buffered saline (PBS) at 23° C. for 24 hours. Then, the contact lens was removed therefrom and was taken to remove all surface water by a long-fiber fabric. After that, the weight of contact lens was measured. Next, the contact lens was dried at 600 W for 5 minutes by microwave and after that the weight of hydrated contact lens was measured. The water contact of contact lens was calculated by the following equation:(the weight of hydrated contact lens−the weight of dried contact lens)/the weight of hydrated contact lens×100%.

### (B) Measurement of Tensile Modulus, Tensile Strength and Elongation Ratio of Contact Lens

The test sample was cut from the middle area of a contact lens into a sample size of 10 mm. Then, the test sample was immersed in a buffer specified in ISO 18369-3 Section 4.7 at 25° C. for 2 hours. After that, in a condition of temperature of 20±5° C. and relative humidity of 55%±10%, the test sample was taken to remove all surface water by a long-fiber fabric and be conducted to proceed tensile modulus and tensile strength measurement by using a test instrument, AI-3000 (available from Gotech Testing Maching Inc.). The measurement was carried out at a constant loading speed of 10 mm/min. The tensile modulus, tensile strength and elongation ratio were determined according to the initial gradient of the strain-stress curve.

### (C) Measurement of Oxygen Permeability of Contact Lens (Dk)

The oxygen permeability (Dk) was measured according to ISO standards 18369-4:2006, 4.4.3, by using a oxygen permeability tester (201T). The units of oxygen permeability (Dk) is defined as 10⁻¹⁰(mlO₂mm)/cm²sec mm Hg.

### (D) Evaluation of Deformation of Contact Lens

The appearance of the contact lens was observed visually to judge whether the deformation occurred or not.

### (E) Evaluation of Discoloration of Contact Lens

The contact lens was put on a stage and a cotton swab was used to rub the surface of the contact lens for 40 times. In final, the surface of the cotton swab was observed visually to judge whether any color fading from the contact lens. “” represents no color fading, “X” represents color fading

As shown in Table 1, in the colored silicon hydrogel contact lens obtained in Examples 1 to 5, the water content is about 46.0% to 47.6%, the tensile modulus is ranging from 0.59 MPa to 0.65 MPa, the tensile strength is ranging from 30 g to 43 g, the elongate ratio is ranging from 68% to 92% and the oxygen permeability (Dk) is about from 119-125.

TABLE 1
The test results of Examples 1-5 and Comparative Example 1

| | | | | | | Compar- |
|---|---|---|---|---|---|---|
| | | | | | | ative |
| Physical | Example | Example | Example | Example | Example | Example |
| properties | 1 | 2 | 3 | 4 | 5 | 1 |
| Tensile | 0.61 | 0.59 | 0.62 | 0.60 | 0.65 | 0.67 |
| Modulus | | | | | | |
| (MPa) | | | | | | |
| Tensile | 40 | 43 | 31 | 38 | 30 | 34 |
| Strength (g) | | | | | | |
| Elongation | 68 | 92 | 86 | 70 | 78 | 74 |
| Ratio (%) | | | | | | |
| Water | 47.0 | 46.2 | 47.1 | 46.0 | 47.6 | 46.6 |
| Content (%) | | | | | | |
| Oxygen | 121 | 125 | 122 | 119 | 123 | 120 |
| Permeability | | | | | | |
| (Dk) | | | | | | |
| Deformation | No | No | No | No | No | No |
| of Contact | | | | | | |
| Lens | | | | | | |
| Discoloration | ⊚ | ⊚ | ⊚ | ⊚ | ⊚ | X |
| of Contact | | | | | | |
| Lens | | | | | | |

The colorant used in the colored layer in Comparative Example 1 was non-modified, the colored silicon hydrogel contact lens faded after the discoloration test. In the silicon hydrogel colored contact lens of Example 1 to Example 5, the colorants of the colored layers were polydopamine-modified colorants so as to provide good color effect without fading and deformation of the lens. Furthermore, the physical properties of the silicon hydrogel colored contact lens of Example 1 to Example 5 were satisfied.

While the invention has been described by way of example(s) and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A colorant composition for colored silicon hydrogel contact lens comprising a polydimethylsiloxane, at least one hydrophilic monomer and a polydopamine-modified colorant.

2. The colorant composition as claimed in claim 1, wherein the polydimethylsiloxane is represented by the following formula (I): 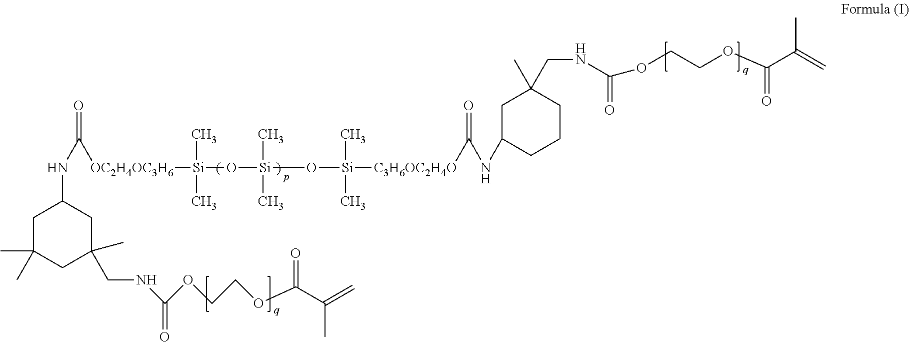
wherein, in Formula (I), p is an integer of 4 to 80 and q is an integer of 3 to 40.

3. The colorant composition as claimed in claim 1, wherein the amount of the polydimethylsiloxane is ranging from 30 weight percent to 65 weight percent relative to the total amount of the colorant composition

4. The colorant composition as claimed in claim 1, wherein thehydrophilic monomer is selected at least one from a group consisting of N-vinylpyrrolidone (NVP), 2-hydroxyethyl methacrylate (HEMA), N,N′-dimethylacrylamide (DMA), methyl acrylic acid (MAA), N,N′-diethylacrylamide, N-isopropylamide, 2-Hydroxypropyl acrylate, vinyl acetate, N-acrylolmorpholine and 2-dimethylaminoethyl acrylate, or combinations thereof.

5. The colorant composition as claimed in claim 1, wherein the amount of the hydrophilic monomer is ranging from 5 weight percent to 20 weight percent relative to the total weight of the colorant composition.

6. The colorant composition as claimed in claim 1, wherein the polydopamine-modified colorant is prepared by the method comprising the steps of:
(a) providing dopamine in an alkaline aqueous solution to form a polydopamine solution;
(b) adding a colorant for colored contact lens into the polydopamine solution and stirring thoroughly to enable the colorant and the polydopamine to react and form a solid-state polydopamine-modified colorant; and
(c) collecting the solid-state polydopamine-modified colorant.

7. The colorant composition as claimed in claim 1, wherein the amount of the polydopamine-modified colorant is ranging from 10 weight percent to 60 weight percent relative to the total weight of the colorant composition.

8. The colorant composition as claimed in claim 1 further comprising an initiator, and/or an anti-blue ray reagent, and/or a UV reagent.

9. A method for modifying the colorant used in the colored silicon hydrogel contact lens comprising the steps of:
(a) providing dopamine in an alkaline aqueous solution to form a polydopamine solution;
(b) adding a colorant for colored contact lens into the polydopamine solution and stirring thoroughly to enable the colorant and the polydopamine to react and form a solid-state polydopamine-modified colorant; and
(c) collecting the solid-state polydopamine-modified colorant.

10. The method as claimed in claim 9, wherein the concentration of the polydopamine solution is ranging between 50 ppm and 1500 ppm

11. The method as claimed in claim 9, wherein the colorant comprises organic colorant or inorganic colorant.

12. The method as claimed in claim 11, wherein the inorganic colorant comprises iron oxide black, iron oxide brown, iron oxide yellow, iron oxide red or titanium dioxide.

13. The method as claimed in claim 11, wherein the organic colorant comprises C.I. Reactive Yellow 14, C.I. Reactive Orange 7, C.I. Reactive Red 23 or C.I. Reactive Blue 19.

14. A colored silicon hydrogel contact lens comprising a silicon hydrogel contact lens; and
a colored layer on one surface of the silicon hydrogel contact lens, wherein the colored layer comprises a colorant composition comprising a polydimethylsiloxane, at least one hydrophilic monomer and a polydopamine-modified colorant.

15. The colored silicon hydrogel contact lens as claimed in claim 14, wherein the polydimethylsiloxane is represented by the following formula (I): 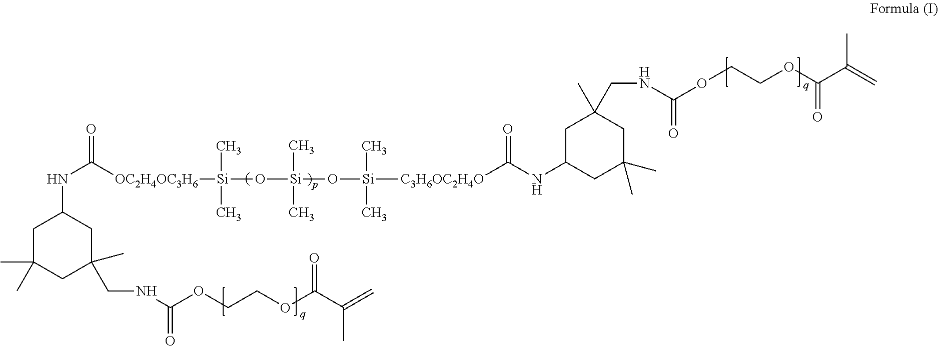
wherein, in Formula (I), p is an integer of 4 to 80 and q is an integer of 3 to 40.

16. The colored silicon hydrogel contact lens as claimed in claim 14, wherein the amount of the polydimethylsiloxane is ranging from 30 weight percent to 65 weight percent relative to the total amount of the colorant composition

17. The colored silicon hydrogel contact lens as claimed in claim 14, wherein thehydrophilic monomer is selected at least one from a group consisting of N-vinylpyrrolidone (NVP), 2-hydroxyethyl methacrylate (HEMA), N,N′-dimethylacrylamide (DMA), methyl acrylic acid (MAA), N,N′-diethylacrylamide, N-isopropylamide, 2-Hydroxypropyl acrylate, vinyl acetate, N-acrylolmorpholine and 2-dimethylaminoethyl acrylate, or combinations thereof.

18. The colored silicon hydrogel contact lens as claimed in claim 14, wherein the amount of the hydrophilic monomer is ranging from 5 weight percent to 20 weight percent relative to the total weight of the colorant composition.

19. The colored silicon hydrogel contact lens as claimed in claim 14, wherein the polydopamine-modified colorant is prepared by the method comprising the steps of:
(a) providing dopamine in an alkaline aqueous solution to form a polydopamine solution;
(b) adding a colorant for colored contact lens into the polydopamine solution and stirring thoroughly to enable the colorant and the polydopamine to react and form a solid-state polydopamine-modified colorant; and
(c) collecting the solid-state polydopamine-modified colorant.

20. The colored silicon hydrogel contact lens as claimed in claim 14, wherein the amount of the polydopamine-modified colorant is ranging from 10 weight percent to 60 weight percent relative to the total weight of the colorant composition.

21. The colored silicon hydrogel contact lens as claimed in claim 14, further comprising an initiator, and/or an anti-blue ray reagent, and/or a UV reagent.
